(19) United States
(12) Patent Application Publication
(10) Pub. No.: US 2005/0114152 A1
(43) Pub. Date: May 26, 2005

(54) Reference solution architecture method and system

(76) Inventors: Alfonso O. Lopez, Plano, TX (US); Nigel P. Cresswell, Claygate (GB); Subhashini Mukundan, Troy, MI (US); Lekha Rao, Bloomfield Hills, MI (US); Gregory W. McCarthy, Sterling Heights, MI (US); Robert A. Laske, Brighton, MI (US); Rebecca G. Miracle, W. Bloomfield, MI (US); Donna K. Seligman, W. Bloomfield, MI (US); Anthony E. Frankland, Derby (GB); Daniel R. Belville, Swartz Creek, MI (US)

Correspondence Address: BAKER BOTTS L.L.P., 2001 ROSS AVENUE, 6TH FLOOR, DALLAS, TX, 75201, US

(21) Appl. No.: 10/719,656

(22) Filed: Nov. 21, 2003

(51) Int. Cl. G06F 17/60

(52) U.S. Cl. 705/1; 705/7

(57) ABSTRACT

A method for harvesting a business solution includes receiving a business solution and creating a logical technology architecture used to implement the business solution. The method also includes categorizing the business solution into a solution type and mapping a plurality of standards used by the business solution.

### TECHNICAL FIELD OF THE INVENTION

The present invention relates generally to business solutions and, more particularly, to a reference solution architecture method and system.

### BACKGROUND OF THE INVENTION

Businesses regularly face complex business problems that require high levels of architecture and expertise. The timeframe in which a solution to such complex problems must be developed is becoming shorter. In many cases, solutions and implementation architecture for various businesses facing similar problems may be the same or similar. In some such circumstances, the actual products used to implement the solutions may be different, as such products may be based on a particular business' direction and/or preferences.

### SUMMARY OF THE INVENTION

The present invention provides a reference solution architecture method and system that substantially eliminates or reduces at least some of the disadvantages and problems associated with previous methods and systems.

In accordance with a particular embodiment of the present invention, a method for harvesting a business solution includes receiving a business solution and creating a logical technology architecture used to implement the business solution. The method also includes categorizing the business solution into a solution type and mapping a plurality of standards used by the business solution.

The method may include adding a workable solution based on the business solution and mapping a plurality of technology products used in the workable solution. The logical technology architecture, the solution type, the plurality of standards, the workable solution and the plurality of technology products may encompass a reference solution architecture. Creating a logical architecture used to implement a reference solution may comprise generalizing a plurality of technology products used to implement the business solution. Categorizing the business solution into a type may comprise categorizing the business solution according to an industry or business domain in which the business solution has been applied. The plurality of standards used by the business solution may comprise at least one of industry standards, industry application framework, application architecture design principle, design patterns and application programming interface.

In accordance with another embodiment, a system for harvesting a business solution includes a memory comprising a reference solution architect. The reference solution architect is operable to receive a business solution and create a logical technology architecture used to implement the business solution. The reference solution architect is also operable to categorize the business solution into a solution type and map a plurality of standards used by the business solution.

The reference solution architect may be further operable to add a workable solution based on the business solution and map a plurality of technology products used in the workable solution. The system may further comprise a database operable to store the logical technology architecture, the solution type, the plurality of standards, the workable solution and the plurality of technology products as a reference solution architecture.

In accordance with another embodiment, a method for creating a business solution from a reference solution architecture model includes receiving a solution purpose and selecting a reference solution architecture for the solution purpose. The reference solution architecture may comprise a logical technology architecture comprising a plurality of logical technology components for the solution purpose, a plurality of standards to be used with the logical technology architecture and a plurality of technology products for the logical technology components.

Technical advantages of particular embodiments of the present invention include the development and use of a reference solution architecture model that provides the ability to quickly implement proven solutions by reusing previously-designed reference solution architectures. The different reference solution architectures may be used as templates to solve a variety of business problems. Technical physical architectures (using specific technology products) may be quickly created by prototyping instances using a particular client's choice of products. Instances of a certain reference solution architecture may be provided across varying lines of business thus increasing flexibility and reducing expenses in providing business solutions.

Another technical advantage of particular embodiments of the present invention includes the ability to harvest a proven business solution into a reference solution architecture that may again be used to solve a different client's business problems or needs. Accordingly, labor time and expense connected with developing new business solutions are reduced.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 illustrates a reference solution architecture model, in accordance with a particular embodiment of the present invention;

FIG. 2 is a flowchart illustrating a method for harvesting a business solution, in accordance with a particular embodiment of the present invention;

FIG. 3 illustrates a system for harvesting a business solution, in accordance with an embodiment of the present invention; and

FIG. 4 is a flowchart illustrating a method for creating a business solution from a reference solution architecture model, in accordance with a particular embodiment of the present invention.

### DETAILED DESCRIPTION OF THE INVENTION

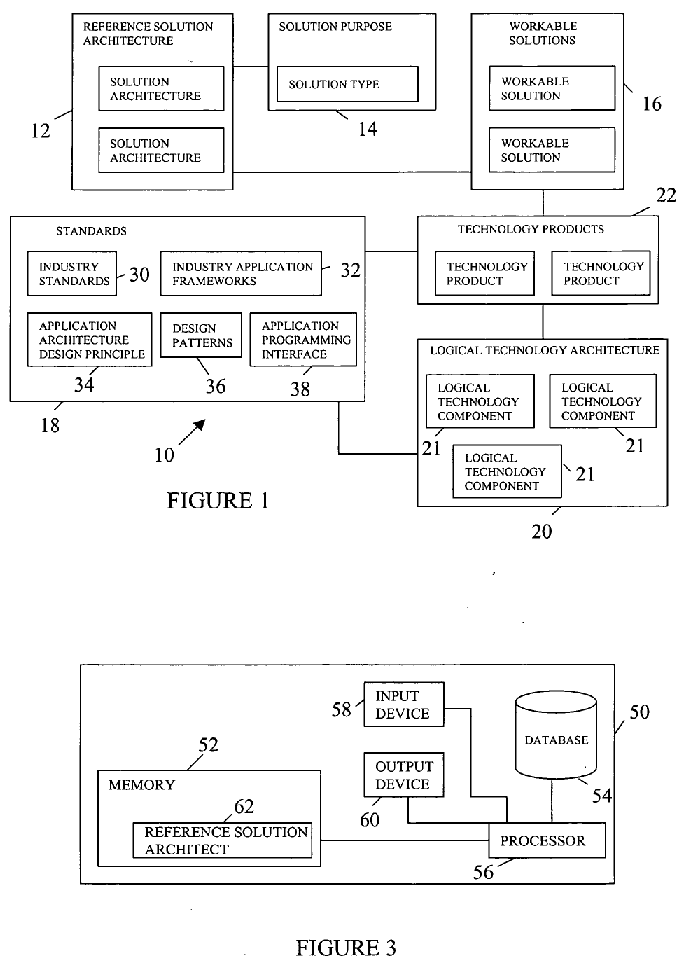

FIG. 1 illustrates a reference solution architecture model 10, in accordance with a particular embodiment of the present invention. Reference solution architecture model 10 includes reference solution architectures 12 grouped using solution architecture objects. A reference solution architecture is an architecture designed to address a business problem within a specific domain. The reference solution architecture provides a reusable solution that may be implemented multiple times using a different set of technology products to solve complex business problems. More specifically, reference solution architectures provide a template specifying components required to resolve a problem within the specific business domain. Thus, reference solution architecture model 10 provides a way to model reference solution architectures and their components for harvesting and reuse from one solution to another.

Reference solution architecture model 10 describes a solution using standards and logical technology components and then links the standards and logical technology components to actual workable solutions and product sets used. In particular embodiments, a reference solution architecture may be created initially from harvesting proven physical architectures into their technology logical components by reverse engineering the solution using model 10.

Reference solution architecture model 10 uses container-object relationships to store information about solution architectures. For example, reference solution architecture model 10 includes reference solution architectures 12, solution purposes 14, workable solutions 16, standards 18, logical technology architecture 20 and technology products 22. In particular embodiments, a specific reference solution architecture 12 designed to solve a particular business problem (e.g., designed for a solution purpose 14) may encompass a logical technology architecture 20 for utilization with one or more standards 18. Particular workable solutions 16 implementing the specific reference solution architecture utilize certain technology products 22. Specific technology products 22 utilized may be different for other workable solutions 16 as preferences and needs of particular clients and businesses vary.

Reference solution architectures 12 include solution architectures that may be identified by name, description, owner, contact or other information. As stated above, reference solution architectures 12 are designed for solution purposes 14. Solution purposes 14 include various purposes for which reference solution architectures may be designed in order to solve business problems. Thus, solution purposes 14 may aid in categorizing types of reference solution architectures in terms of the business problem(s) the architectures are designed to solve.

As indicated above, a specific reference solution architecture 12 may encompass a logical technology architecture 20. Logical technology architecture 20 describes a general build of materials at the logical level for implementing a particular reference solution architecture. Logical technology architecture 20 includes a hierarchical structure that enables technologies to be categorized in technology areas. In particular embodiments, logical technology architecture 20 provides a navigation tree and a clustering of technologies into categories that allows policies and strategies to be assigned to those classifications. Each technology is grouped into a logical technology component 21, which is a logical grouping of physical elements having the same and unique technical characteristic. In particular embodiments, such logical technology architecture technologies may comprise, for example, a web server, an application server or other off-the-shelf component.

In some embodiments, logical technology components 21 of a logical technology architecture 20 may include platform services, network services, data services, security services, extended enterprise integration services and application services. Platform services may, for example, include a midrange application server and associated operating system (OS), a database server and associated OS and an application server and associated OS. Network services may, for example, include protocols such as TCP/IP. Data services may, for example, include a relational database management system (RDBMS) and components for database connectivity, database access, data mapping, data extraction, data cleansing, data transformation, data loading, remote file access and remote data access. Security services may, for example, include an access control component. Extended enterprise integration services may, for example, include an operations manager, a message broker, adapters and connectors and components for gateway communication, gateway data platform, metrics collection, business process management and workflow, message formatting and parsing, gateway data management, services registry, partner management and exchange mechanisms. It should be understood that some or all of the above described technology components may be obtained off-the-shelf for implementation into a particular logical technology architecture of a reference solution architecture. For example, a message broker for extended enterprise integration services may comprise SeeBeyond's e*Gate. Particular reference solution architectures may include some, all or none of the logical technology components described above.

As stated above, a particular reference solution architecture utilizes a logical technology architecture 20 in connection with certain standards 18. Standards 18 provide significant value to an architect designing a reference solution architecture to solve a business problem. In particular embodiments, such standards may include industry standards 30, industry application frameworks 32, application architecture design principle 34, design patterns 36 and application programming interface 38.

Industry standards 30 may comprise recognized information technology (IT) industry standards in general. In particular embodiments, industry standards 30 may include all standards not otherwise categorized in any other standards groups of standards 18. Examples of industry standards 30 may include simple network management protocol (SNMP), hypertext transfer protocol (HTTP), open database connectivity (ODBC), logical unit (LU) 6.2, java database connectivity (JDBC), Healthcare Level 7 (HL7), extensible markup language (XML), electronic data interchange for administration, commerce and transport (EDIFACT) and lightweight directory access protocol (LDAP).

Industry application frameworks 32 include industry application frameworks used to build applications. An industry application framework is an architectural pattern that provides an extensible template for developing solutions to business problems. The specification of a framework includes the skeleton of its architecture, together with the specification of all its components and interactions such that they may be adapted into specific context. In particular embodiments, industry application frameworks 32 may include, for example, Java 2 Platform, Enterprise Edition (J2EE), .NET framework or an industry-specific framework such as Microsoft Healthcare SDK for health care related solutions.

Application architecture design principle 34 describes an application's underpinning design paradigm. In particular embodiments, an application architecture design principle may include a programming model paradigm or an application design paradigm. Application architecture design principles 34 may include, for example, two tier, three tier or object technology.

Design patterns 36 include recurring software design building blocks that identify software design artifacts implemented by an application. In the past, design patterns were applicable only to object oriented projects; however, today design patterns may be applicable in many technology areas. In particular embodiments, design patterns 36 may aid in the mapping of those patterns used by particular technology products selected and patterns that are implemented within a design principle and industry application frameworks. A design pattern may, for example, comprise a model view controller (MVC), an iterator or a broker.

Application programming interface (API) 38 includes standard APIs created to provide access to specific functionality regardless of a particular technology used to implement such functionality. In particular embodiments, standard APIs used by technology products may be mapped with APIs implemented within a particular industry application framework. APIs 38 may include, for example, Portable Operating System Interface (POSIX) or J2EE Java Message Service (JMS).

Workable solutions 16 includes solutions that have been designed, implemented and/or operated by a particular designer or architect for one or more clients. Workable solutions include logical technology components 21 converted into specific technology products 22. Workable solutions 16 may include, for example, EDS Extended Enterprise Integration Backbone (EEIB).

As discussed above, technology products 22 are used in the implementation of reference solution architectures and may vary according to the particular workable solution 16 at hand. Logical technology components 21 implement specific technology products 22. For example, if a certain architecture required a web server as a technology component 21, the specific technology product 22 used may be Microsoft Internet Information Services (IIS) or BEA WebLogic.

It should be understood that the combination of a reference solution architecture 12, a solution purpose 14, standards 18 and a logical technology architecture 20 indicate a logical concept used to describe a generic architecture that addresses a business problem but without describing specific products that may be used to solve the problem. Instead, such combination identifies a suite of component types for the solution.

The specific technology products 22 and workable solution 16 provide the physical set of components for the logical concept described above. Thus, the identification of specific technology products 22 completes the architecture for a specific workable solution 16. The workable solution 16 comprises a physical instance of a reference solution architecture. A user of model 10 may identify a reference solution architecture 12 to solve a particular client's problem and may utilize a certain workable solution 16 with specific technology products 22 that has previously been used or may select other workable solutions 16 and technology products 22 to suit the particular client's needs. For example, the client may have its own suite of technology products which it desires to be implemented into a reference solution architecture to solve its particular business problem. A plurality of difference instances of the same reference solution architecture may exist through the variation of the set of technology products used in such architecture.

The development and use of reference solution architecture model 10 provides the ability to quickly implement proven solutions by reusing previously-designed reference solution architectures. The different reference solution architectures 12 may be used as templates to solve a variety of business problems. As described above, technical physical architectures (using specific technology products) may be quickly created by prototyping instances using a particular client's choice of products. Instances of a certain reference solution architecture may be provided across varying lines of business thus increasing flexibility and reducing expenses in providing business solutions. Moreover, mature architectures may be better used to solve business problems in connection with emerging and newer technology areas.

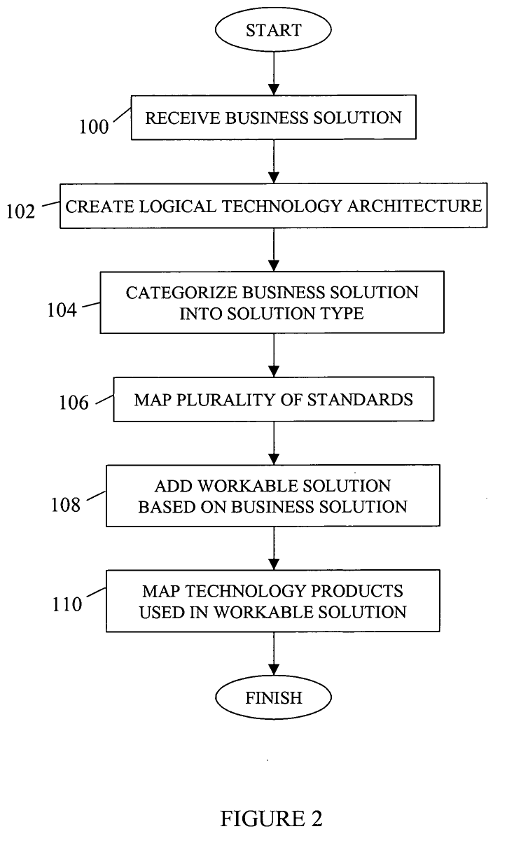

FIG. 2 is a flowchart illustrating a method for harvesting a business solution, in accordance with a particular embodiment of the present invention. This method may be used to create a reference solution architecture from a previously designed or implemented business solution. Such business solution may have been designed or implemented to solve a business problem of a client. The created reference solution architecture may be based on the model described with respect to FIG. 1.

The method begins at step 100 where a business solution is received. The business solution may be received at an input device such as that described below with respect to FIG. 3. The business solution may comprise an architecture and technology products implemented for a particular solution purpose to solve a client's business problem. At step 102, a logical technology architecture is created. Such creation may include generalizing technology products used in the business solution by categorizing such products into their logical technology components. For example, if Microsoft IIS was used in the business solution, then such product would be categorized into its logical technology component, a web server, in the creation of the logical technology architecture.

At step 104, the business solution is categorized into a solution type. This step may include describing the solution type and associated solution architecture according to an industry and/or business domain in which the solution has been applied. Particular solution types may apply to all industries. An example of a business domain into which a particular solution type may be categorized is a business-to-employee (B2E) business domain. At step 106, a plurality of standards used by the solution are mapped. Such mapping may include categorizing the standards used by the solution and the logical technology architecture. For example, the standards used may be categorized into industry standards (e.g., JDBC, SNMP), industry application frameworks (e.g., J2EE, CORBA), application architecture design principle (e.g., 3-tier, DCOM), design pattern (e.g., aggregation, broker) and application programming interface (e.g., POSIX, SOAP).

At step 108, a workable solution is added. This step may include adding the physical solution as a workable instance of a reference architecture. A new workable solution may be added each time a particular reference solution architecture is reused. At step 110, the technology products used in the particular added workable solution are mapped. The combination of the created logical technology architecture, the solution type, the mapped standards, the added workable solution and the technology products used may encompass a reference solution architecture which may be reused for a different solution purpose to solve another client's business problem. In some cases, a similar architecture may be used with different technology products and resultant workable solution depending on a particular client's operational and product compatibility.

FIG. 3 illustrates a system 50 for harvesting a business solution, in accordance with an embodiment of the present invention. System 50 includes a memory 52, a database 54 a processor 56, an input device 58 and an output device 60. Processor 56 is typically a microprocessor, controller or any other suitable computing device or resource. Processor 56 is adapted to execute various types of computer instructions in various computer languages for implementing functions available within system 50.

Memory 52 may be any form of volatile or non-volatile memory including, without limitation, magnetic media, optical media, random access memory (RAM), read-only (ROM), removable media or any other suitable memory component. Memory 52 includes components or software executable by processor 56. Components of memory 52 may be otherwise combined and/or divided for processing within the scope of the present invention.

Memory 52 includes a reference solution architect 62. Reference solution architect 62 may be used to harvest a business solution to create a reference solution architecture in a manner as described above with respect to FIG. 2. In particular embodiments, reference solution architect 62 may be used to create a business solution from, or based upon, a reference solution architecture model, such as model 10 discussed with respect to FIG. 1. In order to create a business solution, a user may view and initially select any of a number of components of a reference solution architecture, such as logical technology architecture, standards, workable solution, solution type or solution purpose. Thus, the components of a particular business solution may be selected in any suitable order. In particular embodiments, reference solution architect 62 may be combined into or encompassed in any number of components. For example, in some embodiment, reference solution architect 62 may include a separated component for creating the business solution.

Database 54 acts as a storage vehicle for system 50. Database 54 may include various types of data and information used by reference solution architect 62. For example, database 54 may include technology products, logical technology architecture, standards, workable solutions, solution types or solution purposes previously used or implemented in business solutions. Such data and information may be used by reference solution architect 62 in creating new business solutions or in harvesting previously implemented business solutions into reference solution architectures.

System 50 also includes an input device 58 and an output device 60. Input device 58 may be a keyboard, mouse, touch pad or any other suitable component for inputting information into the system. In particular embodiments, one or more components of a reference solution architecture may be input into the system. In some embodiments, a business solution comprising standards, logical technology and other components for harvesting by reference solution architect 62 may be input using input device 58. Output device 60 may be a disk drive, printer, display or any other component for outputting information such as a business solution harvested into a reference solution architecture. In particular embodiments, system 50 may include other components, such as a modem for making connections to external communication media.

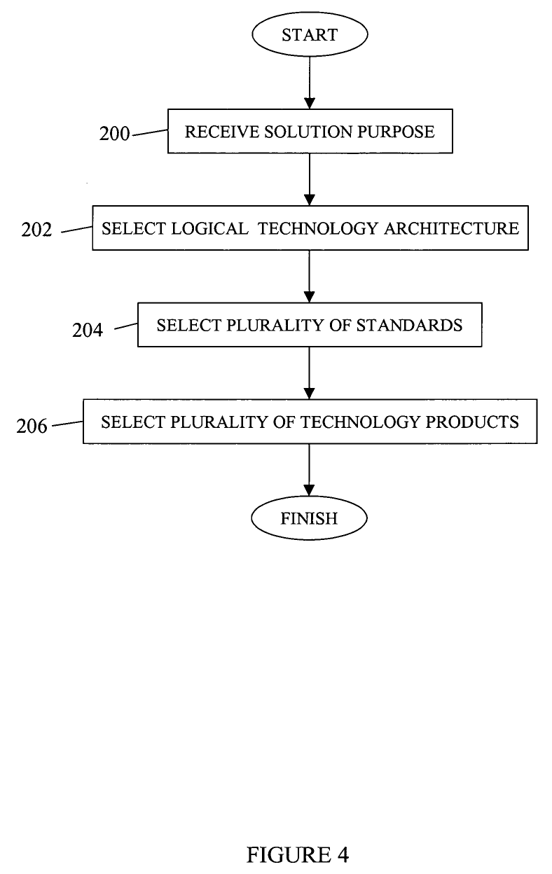

FIG. 4 is a flowchart illustrating a method for creating a business solution from a reference solution architecture model, in accordance with a particular embodiment of the present invention. The method begins at step 200 where a solution purpose is received. The solution purpose may be received from a client to solve the client's particular business problem. Next, a reference solution architecture is selected to implement a business solution for the solution purpose. The selection of a reference solution architecture may encompass the next few steps of the illustrated flowchart. At step 202, a logical technology architecture is selected for the solution purpose. At step 204, a plurality of standards to be used with the logical technology architecture are selected. At step 206, a plurality of technology products for logical technology components of the logical technology architecture are selected. The selection steps above create the business solution using the reference solution architecture model described with respect to FIG. 1. The selection of the technology products for the logical technology architecture and the standards may encompass a workable solution for client.

Some of the steps illustrated in FIGS. 2 and 4 may be combined, modified or deleted where appropriate, and additional steps may also be added to the flowchart. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within reference solution architecture model 10 and system 50, these elements may be combined, rearranged or positioned in order to accommodate particular routing architectures or needs. In addition, any of these elements may be provided as separate external components where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

1. A method for harvesting a business solution, comprising:
receiving a business solution;
creating a logical technology architecture used to implement the business solution;
categorizing the business solution into a solution type; and
mapping a plurality of standards used by the business solution.

2. The method of claim 1, further comprising:
adding a workable solution based on the business solution; and
mapping a plurality of technology products used in the workable solution.

3. The method of claim 2, wherein the logical technology architecture, the solution type, the plurality of standards, the workable solution and the plurality of technology products encompass a reference solution architecture.

4. The method of claim 1, wherein creating a logical architecture used to implement a reference solution comprises generalizing a plurality of technology products used to implement the business solution.

5. The method of claim 1, wherein categorizing the business solution into a type comprises categorizing the business solution according to an industry in which the business solution has been applied.

6. The method of claim 1, wherein categorizing the business solution into a type comprises categorizing the business solution according to a business domain in which the business solution has been applied.

7. The method of claim 1, wherein the plurality of standards used by the business solution comprise at least one of industry standards, industry application framework, application architecture design principle, design patterns and application programming interface.

8. A system for harvesting a business solution, comprising:
a memory comprising a reference solution architect operable to:
receive a business solution;
create a logical technology architecture used to implement the business solution;
categorize the business solution into a solution type; and
map a plurality of standards used by the business solution.

9. The system of claim 8, wherein the reference solution architect is further operable to:
add a workable solution based on the business solution; and
map a plurality of technology products used in the workable solution.

10. The system of claim 9, further comprising a database operable to store the logical technology architecture, the solution type, the plurality of standards, the workable solution and the plurality of technology products as a reference solution architecture.

11. The system of claim 8, wherein a reference solution architect operable to create a logical architecture used to implement a reference solution comprises a reference solution architect operable to generalize a plurality of technology products used to implement the business solution.

12. The system of claim 8, wherein a reference solution architect operable to categorize the business solution into a type comprises a reference solution architect operable to categorize the business solution according to an industry in which the business solution has been applied.

13. The system of claim 8, wherein a reference solution architect operable to categorize the business solution into a type comprises a reference solution architect operable to categorize the business solution according to a business domain in which the business solution has been applied.

14. The system of claim 8, wherein the plurality of standards used by the business solution comprise at least one of industry standards, industry application framework, application architecture design principle, design patterns and application programming interface.

15. A reference solution architecture based on a model, comprising:
a solution purpose for a business solution;
a logical technology architecture comprising a plurality of logical technology components for implementing the business solution; and
a plurality of standards associated with the logical technology components for implementing the business solution.

16. The architecture of claim 15, further comprising:
a workable solution based on the business solution; and
a plurality of technology products used in the workable solution, the plurality of technology products associated with the logical technology components.

17. The architecture of claim 15, wherein the plurality of standards comprise at least one of industry standards, industry application framework, application architecture design principle, design patterns and application programming interface.

18. A method for creating a business solution from a reference solution architecture model;
receiving a solution purpose; and
selecting a reference solution architecture for the solution purpose, the reference solution architecture comprising:
a logical technology architecture comprising a plurality of logical technology components for the solution purpose;
a plurality of standards to be used with the logical technology architecture; and
a plurality of technology products for the logical technology components.

19. The method of claim 18, wherein the plurality of standards comprise at least one of industry standards, industry application framework, application architecture design principle, design patterns and application programming interface.
